(19) United States
(12) Patent Application Publication
(10) Pub. No.: US 2024/0389553 A1
(43) Pub. Date: Nov. 28, 2024

(54) HAIR COLLECTOR WITH VACUUM FUNCTION

(71) Applicant: Seçgin Serifoglu, Istanbul (TR)

(72) Inventor: Seçgin Serifoglu, Istanbul (TR)

(21) Appl. No.: 18/200,167

(22) Filed: May 22, 2023

(51) Int. Cl. A01K 13/00

(52) U.S. Cl. CPC A01K 13/001

(57) ABSTRACT

A hair collector to clean the hair or fur of the animals is provided that incudes at least one part and at least one coupling apparatus that couples the parts to form the main body thereof with an animal accessible inlet. A ventilated lid that covers the inlet, at least one locking mechanism that prevents it after the entry lid is closed and at least one chamber with a diameter such that a hand of any size can easily enter, and a connection apparatus that allows a connection with any vacuuming device in order to vacuum the chamber that allows the animal to be combed in the hair collector when hands are fitted therein and the area where the hair is shed such that only one hole is open. At least one additional chamber is positioned below a monitoring unit.

### FIELD OF THE INVENTION

The invention relates to a hair collector with vacuum function that cleans the hair of furry animals without spreading it into the environment where it is cleaned and without contaminating their owner.

### BACKGROUND OF THE INVENTION

The hair of all animals such as cat, dog, rabbit, etc. that are fed indoors is a common problem of all animal lovers. Anyone who feeds cats, dogs, etc. suffers from hair shed on the environment. In the products in the state of the art, comb, brush, comb and glove equipment with comb are used by combing/rubbing/collecting the hair to get rid of the hair. However, the hair of the animals combed with these equipments still contaminates the environment and the person combing it. In addition, it is necessary to use these equipments outside, not indoors. Because when animals are combed with the equipment in question, the combed hair is spread around again.

Animal owners are too lazy to go out to comb their animals and even when they comb their animals outside, the hair sticks to their hands, face and clothes.

In the state of the art, the products in the links below are gloves and the animal's hair is collected with gloves. However, although the products in question collect animal hair, since the animal is combed outside, the hair or fur contaminates the environment or the clothes of the person combing.

In order to turn these disadvantages into an advantage in the products in the state of the art, there is a need for products that do not contaminate the animal owner while combing the hair of the animals, do not spread it around while combing, and enable to comb the hair without changing the location.

### SUMMARY OF THE INVENTION

The object of the invention is to produce a hair collector that cleans the hair of animals such as cats, dogs, rabbits, etc., without contaminating the clothes of the person combing it and without spreading to the environment where it is cleaned.

The hair collector according to the invention has a vacuum function. In addition, the hair of any animal that is large enough to fit into the volume of the collector is easily cleaned. On the other hand, the hair collector is also produced in different sizes to accommodate animals such as cats and dogs of all sizes.

The hair collector of the invention is a product that does not contaminate the owner of the animal while combing the hair of the animals and does not spread it around while combing, as well as allows the hair to be combed without changing the location.

### BRIEF DESCRIPTION OF THE DRAWINGS

FIG. 1. Perspective representative view of the hair collector of the invention.

FIG. 2. Representative view of the hair collector of the invention from one side, for example from the animal entry side.

FIG. 3. Representative view of the hair collector of the invention from another side, for example from the side where the vacuum apparatus is positioned.

FIG. 4. Representative view of the hair collector of the invention from one side, for example, from the side where the hair combing member is positioned.

FIG. 5. Perspective top representative view of the hair collector of the invention from one side, for example, vacuum entry side.

FIG. 6. Top representative view of the hair collector of the invention.

FIG. 7. Perspective representative view of the hair collector of the invention from one side, for example, from the side where the hair combing member is positioned.

FIG. 8. Perspective view from a representative side of the clothing contained in an embodiment of the hair collector of the invention.

FIG. 9. Perspective view from another representative side of the clothing contained in the hair collector of the invention.

FIG. 10. Representative front view of the lids that the user positions in the chamber at any time.

FIG. 11. Representative front view of the lids that the user positions at the inlet of the invention at any time.

FIG. 12. Perspective representative view of another exemplary embodiment of the hair collector of the invention.

FIG. 13. Representative view of another exemplary embodiment of the hair collector of the invention from one side.

FIG. 14. Representative view of another exemplary embodiment of the hair collector of the invention from the lid side.

FIG. 15. Representative view of another exemplary embodiment of the hair collector of the invention from the vacuum entry side.

FIG. 16. Representative view of another exemplary embodiment of the hair collector of the invention from the side where the chamber is positioned.

FIG. 17. Perspective representative view of another exemplary embodiment of the hair collector of the invention.

FIG. 18. Top representative view of another exemplary embodiment of the hair collector of the invention.

FIG. 19. Representative view of the lid in another exemplary embodiment of the hair collector of the invention.

FIG. 20. Other representative views of the lids in another exemplary embodiment of the hair collector of the invention.

FIG. 21. Representative front view of the lid in another exemplary embodiment of the hair collector of the invention.

FIG. 22. Representative front view of another lid in another exemplary embodiment of the hair collector of the invention.

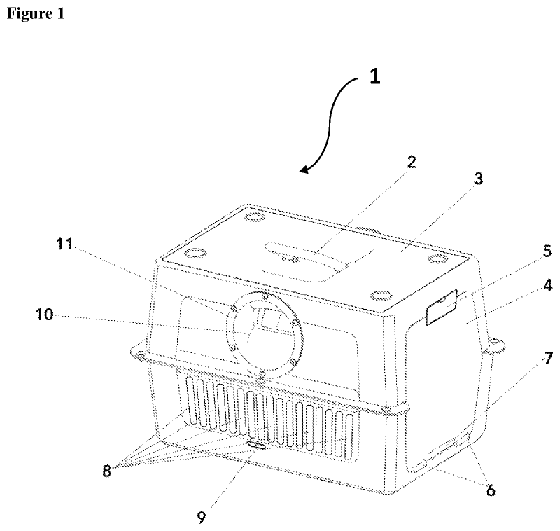

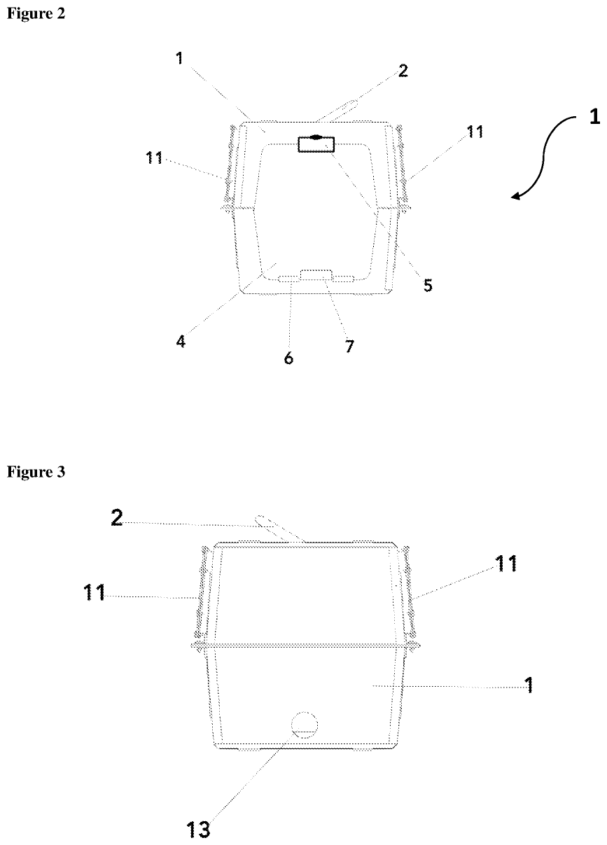

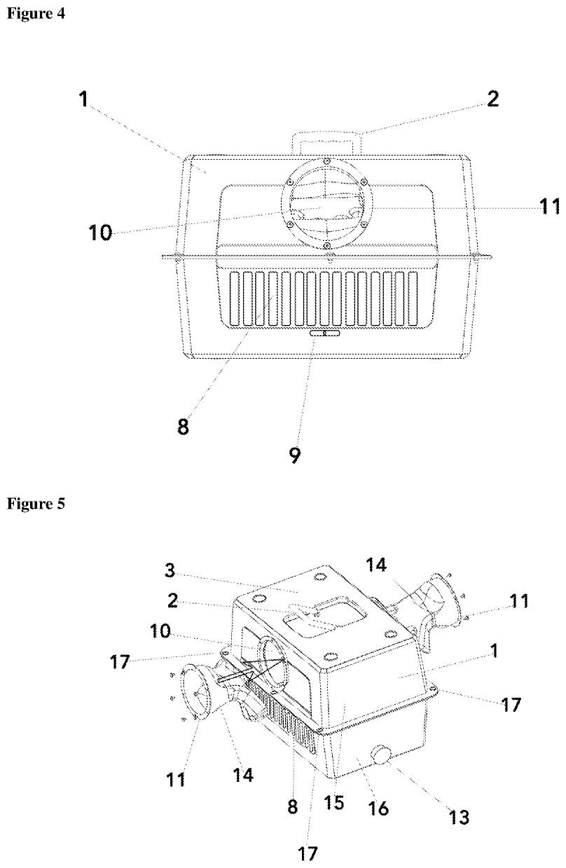

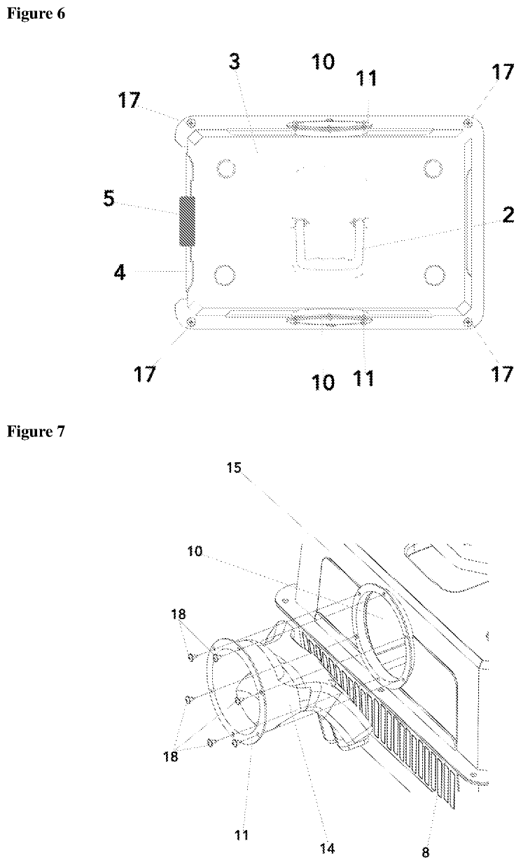

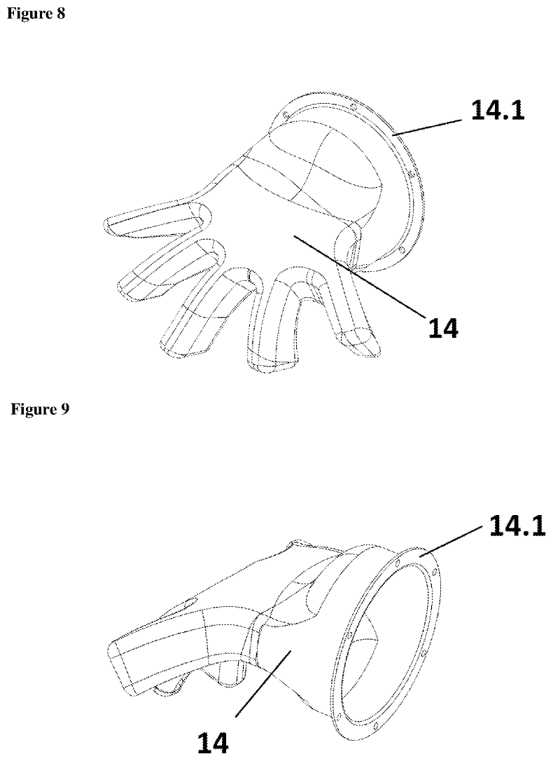

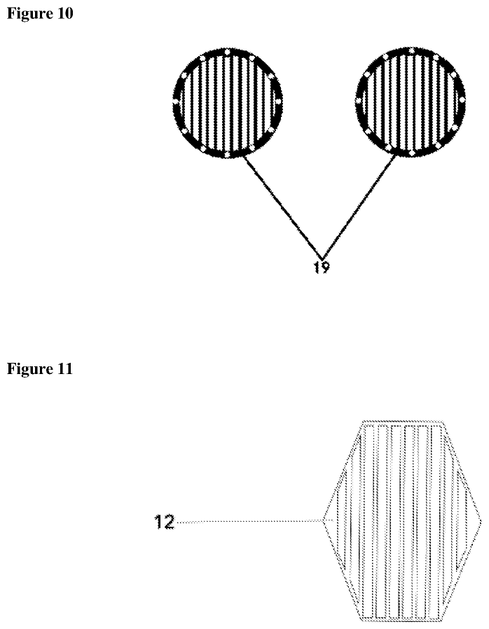

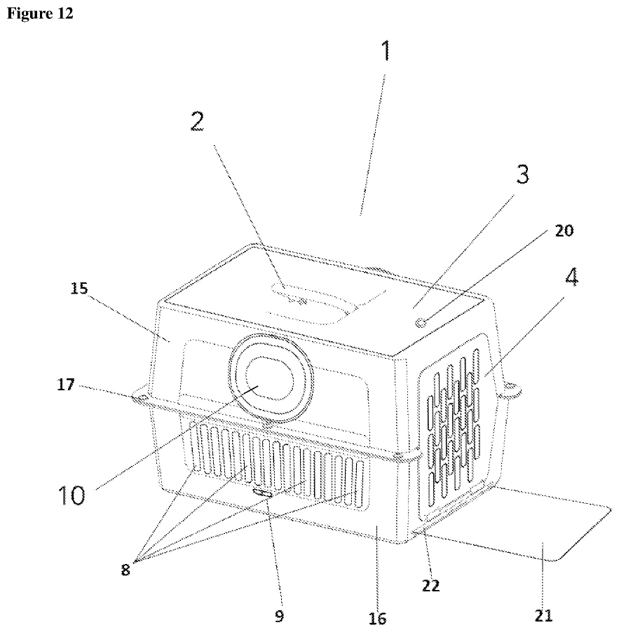

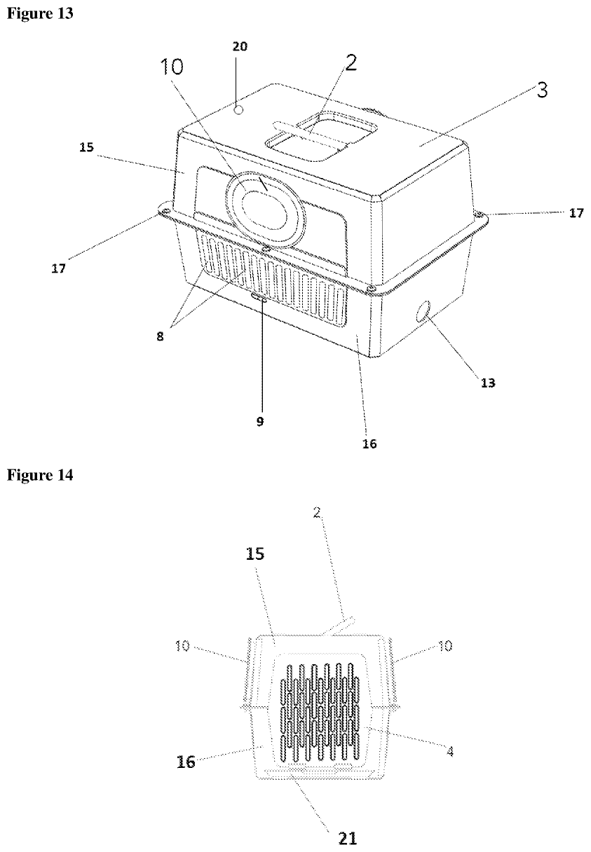

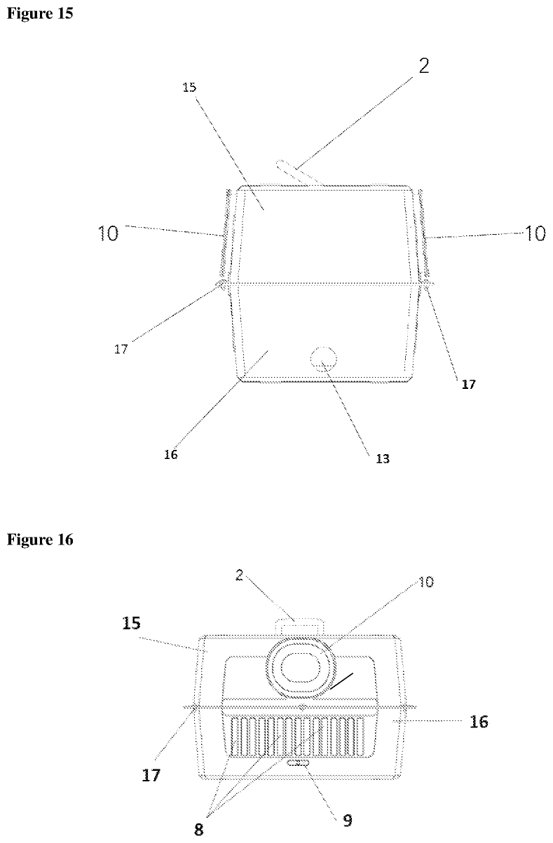

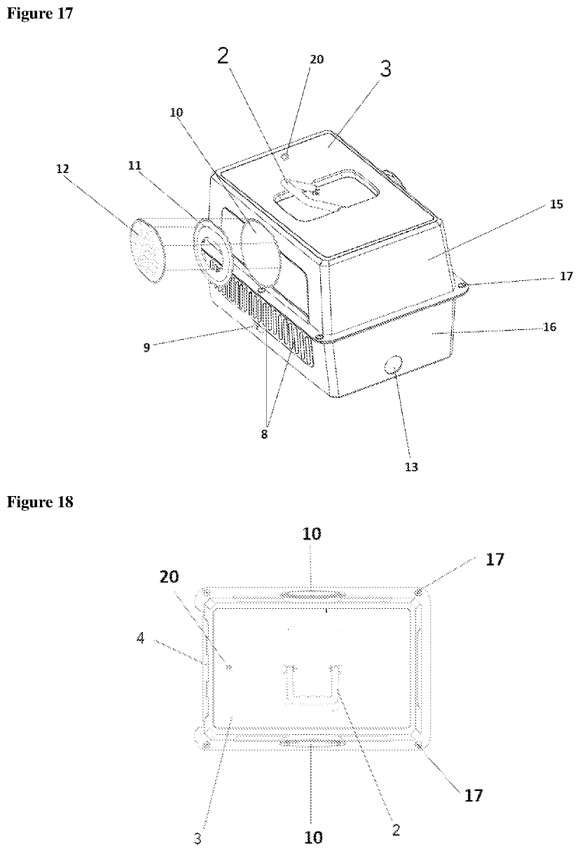

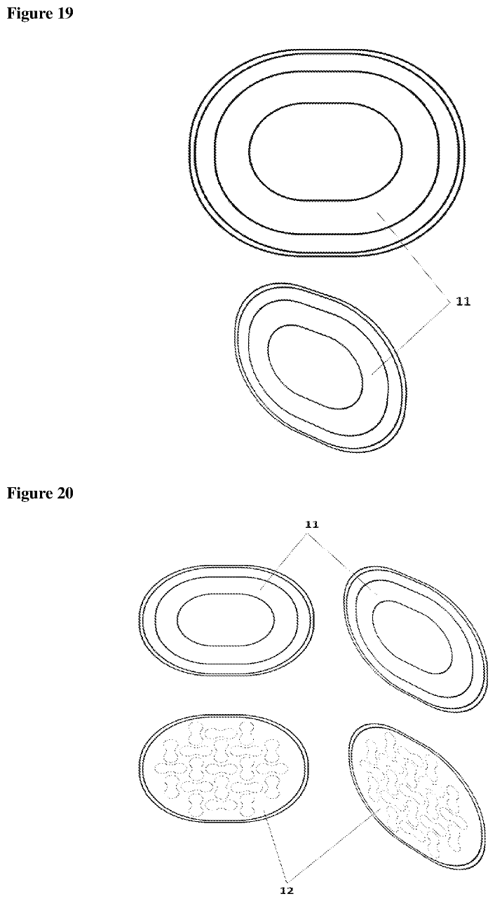

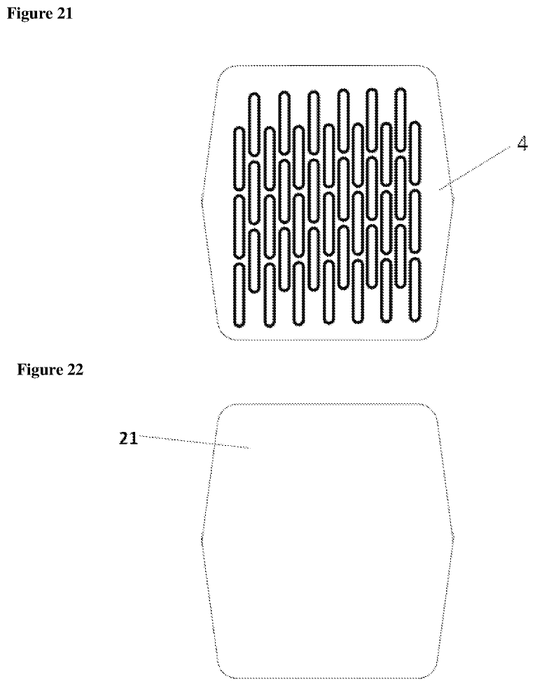

### THE DESCRIPTION OF REFERENCES IN FIGURES

In order to better understand the invention, the numbers in the figures are given below:
Hair collector
Carrying apparatus
Monitoring unit
Lid
Locking mechanism
Connection part
Hole
Ventilation mechanism
Button
Chamber
Mounting apparatus
Lid
Connection apparatus
Clothing
Mounting apparatus
First part
Second part
Coupling apparatus
Fastening apparatus
Lid
Chamber
Lid
Hole

### DETAILED DESCRIPTION OF THE INVENTION

The hair collector 1 is a product that cleans the hair (or fur or parasites or other rashes from the animal) of the animals such as cat, dog, rabbit, etc., which are fed indoors or outdoors, without contaminating the clothes of the person combing it and spreading it into the environment where it is cleaned (or combed).

In one embodiment, the hair collector 1 of the invention comprises at least one part (not shown and numbered in the representative figures) and at least one coupling apparatus that couples the said parts to form the body of the hair collector 1.

In another embodiment, the hair collector 1 of the invention comprises a first part 15, a second part 16 and at least one part coupling apparatus 17 coupling the said first part 15 and the second part 16, to form the body of the hair collector 1.

The hair collector 1 comprises at least one carrying apparatus 2, at least one monitoring unit 3 in order to monitor the animal, at least one inlet that allows the animal to enter into the hair collector 1, and a lid 4 that covers the said inlet, at least one locking mechanism 5 that prevents the animal from exiting after the entry lid 4 is closed, at least one connection part 6 that couples the entry lid 4 to the hair collector 1 in the open position, at least one hole 7 in order to allow air inlet and outlet, at least one ventilation mechanism 8 that regulates the inlet and outlet of the air therein, and at least one button 9 that allows the inlet and outlet of air with the said mechanism, at least one chamber 10 with a diameter such that a handwear 14 or a hand of any size enabling to collect the hair can easily enter, at least one mounting apparatus 11, 14.1 in order to mount the hand-worn clothing 14, at least one porous lid 12 located in place of the entry lid 4 for the animal to breath, and a connection apparatus 13 that establishes connection with any vacuuming device in order to vacuum the area where the hair is shed as a result of combing. Also, depending on the user's request, the hair collector 1 comprises at least one lid 19 that can be mounted on the chamber 10 when the clothing 14 is not used. Said lid 19 is preferably in a perforated or gridded structure to allow ventilation. The lid 19 in the form of a grid can be closed and opened at any time. In an embodiment of the present invention, the clothing 14 can be positioned, fastened or disassembled to the mounting apparatus 11 contained in the hair collector 1 with the mounting apparatus 14.1 it contains. The lids 12, 19 positioned on the lint collector 1 can be brought to the closed position at the moment of hair or fur removal. At other times it is brought to open position. If the lids 12, 19 are in a perforated structure, they can be positioned to the hair collector 1 without making any position changes.

In an embodiment of the present invention, during combing the hair, the ventilation mechanisms 8 that provide all ventilation are closed and vacuuming is performed such that only one hole 7 remains open. In another embodiment of the present invention, during transporting the hair collector 1, at least one lid 19 is attached to the chamber 10 and/or a lid 12 is attached to an inlet and all ventilation mechanisms 8 and lids 12, 19 included in the hair collector 1 are kept in a position to allow air to enter.

On the other hand, the carrying apparatus 2 included in the hair collector 1 is preferably a handle and enables the animal to be transported to the desired location. Therefore, the hair collector 1 is also an animal carrying container when its function is not performed. In the invention, the monitoring unit 3 has a structure through which the animal can be seen inside the hair collector 1 and is preferably transparent. The ventilation mechanism 8 is preferably an aperture, but in practice it is not limited thereto. In the invention, the mounting apparatus 11, 14.1 is preferably in the form of a ring, but in practice it is not limited thereto.

In an embodiment of the invention, the hair collector 1 comprises; at least one hand-worn clothing 14 to collect and clean animal hair (or fur) and at least one fastening apparatus 18 for fastening the mounting apparatus 14.1 contained in the said clothing 14 to the chamber 10. The clothing 14 can be attached and detached from the hair collector 1 with its mounting apparatus 14.1. After the mounting apparatus 14.1 is positioned in the hair collector chamber 10, it is fastened to the mounting apparatus 11 contained in the chamber 10 through the fastening apparatus 18. Therefore, the fastening apparatus 18 fastens the mounting apparatus 14.1 to the chamber 10 after the user positions the mounting apparatus 14.1 contained in the clothing 14 to another mounting apparatus 11.

In another embodiment of the present invention, the clothing 14 can be inserted directly into the chamber 10 without the mounting apparatus 11, 14.1. The hand-worn clothing 14 is preferably a glove, but in practice it is not limited thereto. The clothing 14 has a structure to collect the hair while combing the animal. The clothing 14 has a structure to gently and easily collect the hair (or fur) without harming the animal, preferably the surface in contact with the animal has a rubber structure. It is also made of a material that will absorb the tooth or nail impacts of aggressive animals (such as cats). In another embodiment, the clothing 14 has a static structure to collect the hair. The clothing 14 is more preferably of a spiky structure. After the animal is rubbed with the clothing 14, the hair that shed into the hair collector 1 or stick to the clothing 14 are cleaned by hand in the hair collector 1, it is ensured that the hair (or fur) is shed therein and the hair (or fur) that shed out or fly are vacuumed with this device by positioning any vacuuming device to the connection apparatus 13. Thus, the flying hair in the hair collector 1 is vacuumed with a vacuuming device without contaminating the house and/or animal owner.

In another embodiment of the invention, when hands are fitted into the reservoir 10, if the user has a comb or brush, the animal is combed in the hair collector 1 with the said tools. Thus, the hair (or fur) shed into the hair collector 1 remains inside and by positioning any vacuuming device to the connection apparatus 13, the shed hair (or fur) is vacuumed via this device.

In the invention, the coupling apparatus 17 is preferably in the form of a clip.

The hair collector 1 has a geometric structure that the animal can easily fit in when it is inside, and preferably has a rectangular prism structure.

Briefly, the hair collector 1 of the invention ensures that the animal hair are combed/collected without contaminating the environment where it is fed or its owner. The hair of the animal being rubbed/combed in the hair collector 1 remains inside.

When the animal is inside, the sound of the vacuuming device does not disturb the animal inside, since the vacuuming device remains away from the hair collector 1 due to its hose length.

In another embodiment of the invention, it comprises at least one chamber 20 positioned below the monitoring unit 3. The hole of the said chamber 20 is on the monitoring unit 3. The body of the chamber 20 is located inside the hair collector 1. Said chamber 20 comprises at least one roll-on mechanism (not shown in the figures) positioned below. The chamber 20 also comprises at least one lid (not shown in the figures) thereon. The user/animal owner can lift the lid of the chamber 20 and add food in cream form produced for pets such as cats, dogs, rabbits, etc. With the roll-on mechanism, the animal can easily lick/consume the food added into the chamber 20. The chamber 20 with the roll-on mechanism allows the pet to voluntarily enter the hair collector 1 to lick the roll-on and spend more time in the hair collector 1.

In another embodiment of the invention, the lid 12 is removed when the vacuum function of the hair collector 1 is to be used. At least one lid 21 positioned in the hole 22 at the bottom of the hair collector 1 is attached in place of the removed lid 12. Said lid 21 is preferably in a flat and/or non-perforated structure, which is developed to prevent ventilation. Said hole 22 is larger than the hole 7 in the previous embodiment of the invention and is of a size that the lid 21 can fit through. When the vacuum function is activated, the operation of the hair collector 1 is as follows: the ventilation mechanism 8 is closed by a button 9 which allows air inlet and outlet. Any vacuuming device positioned in the connection apparatus 13 vacuums the air entering through the hole 22 through which the lid 21 is removed. During vacuuming, the user/animal owner who inserts their hands into the chambers 10 rubs the animal's hair and allows the hair to fall into the box and the shed hair is vacuumed by the vacuum device. With the said structure of the hair collector 1 of the invention, 98 percent of the hair on the entire floor is collected. The fact that the only air inlet to the hair collector 1 is from the front side, i.e. through the hole 22, and the outlet is from the back side, i.e. through the connection apparatus 13, ensures that all the hair on the floor is swept from front to back. Closing the air inlets and adjusting the air flow structure in this way ensures such efficiency.

In another embodiment of the invention, the hair collector 1 comprises at least one wheel (not shown in the figures). The hair collector 1 comprises at least one pull arm (not shown in the figures). The said pull arm is preferably in telescopic form, but not limited to this in practice. With the pull arm and wheels, the hair collector 1 can be moved as desired by the user.

### INDUSTRIAL APPLICABILITY OF THE INVENTION

The hair collector 1 of the invention is industrially applicable to be used in the hair and fur cleaning of animals fed in indoor or outdoor environments.

The invention is not limited to the above exemplary embodiments, and a person skilled in the art can easily demonstrate different embodiments of the invention. These should be considered within the scope of the protection claimed by the claims of the invention.

1. A hair collector 1, characterized in that in order to clean the hair or fur or parasites or other rashes from an animal without contaminating the clothes of the person combing it and spreading it into the environment where it is cleaned, the hair collector comprises;
at least one part and at least one coupling apparatus that couples the said parts to form the main body thereof, at least one inlet that allows the animal to enter into the hair collector 1, a lid 4 that covers the said inlet, at least one locking mechanism 5 that prevents it after the entry lid 4 is closed, at least one hole 7 in order to allow air inlet and outlet, at least one ventilation mechanism 8 that regulates the inlet and outlet of the air therein and at least one chamber 10 with a diameter such that a hand of any size can easily enter; in that the hair collector comprises a connection apparatus 13 that allows a connection with any vacuuming device in order to vacuum said chamber 10 that allows the animal to be combed in the hair collector 1 when hands are fitted therein and the area where the hair is shed as a result of combing such that only one hole 7 is open wherein at least one chamber 20 is positioned above said chamber and below a monitoring unit 3.

2. The hair collector 1 according to claim 1, characterized by the ventilation mechanism 8 that is closed during combing the hair and provides all ventilation.

3. The hair collector 1 according to claim 2, characterized by the ventilation mechanism 8 which is an aperture.

4. The hair collector 1 according to claim 3, characterized by at least one hand-worn clothing 14 in order to collect and clean the hair of animal.

5. The hair collector 1 according to claim 4, characterized by a connection apparatus 13 that provides a connection with any vacuuming device to vacuum the area where the hair is shed, spread, and flying after it is ensured that the hair is shed therein such that after the animal is rubbed with the clothing 14, the hair (or fur) shed in the hair collector 1 or stick to the clothing 14 is cleaned by hand in the hair collector 1.

6. The hair collector 1 according to claim 5, characterized by a clothing 14 having a structure to collect the hair.

7. The hair collector 1 according to claim 6, characterized by a clothing 14, the surface of which in contact with the animal has a rubber structure.

8. The hair collector 1 according to claim 7, characterized by a clothing 14 having a static structure or a spiky structure to collect the hair.

9. The hair collector 1 according to claim 8, characterized by a clothing 14 which is a glove.

10. The hair collector 1 according to claim 1, characterized by at least one lid 19 that is optionally perforated or a grid structure that can be mounted on the chamber 10 when the clothing 14 is not used.

11. The hair collector 1 according to claim 10, characterized by at least one mounting apparatus 11, 14.1 in order to mount the hand-worn clothing 14.

12. The hair collector 1 according to claim 11, characterized by at least one fastening apparatus 18 that fastens the mounting apparatus 14.1 to the chamber 10 after the user positions the mounting apparatus 14.1 contained in the clothing 14 to another mounting apparatus 11.

13. The hair collector 1 according to claim 12, characterized by the mounting apparatus 11, 14.1 having a ring structure.

14. The hair collector 1 according to claim 13, characterized by at least one porous lid 12 located in place of the entry lid 4.

15. The hair collector 1 according to claim 14, characterized by at least one monitoring unit 3 being transparent to monitor the animal and allowing the animal to be seen.

16. The hair collector 1 according to claim 1, characterized by the at least one chamber 20 adapted to receive food in cream form added, and comprising at least one roll-on mechanism and at least one lid.

17. The hair collector 1 according to claim 16, characterized by comprising at least one pull arm and at least one wheel, which facilitates transport by the user.

18. The hair collector 1 according to claim 17, characterized by comprising at least one pull arm in telescopic form.

19. The hair collector 1 according to claim 18, characterized by comprising at least one lid 21 having a flat and/or non-perforated structure developed to prevent ventilation, which is positioned in place of the lid 12 when the vacuum function is to be used.

20. The hair collector 1 according to claim 19, characterized by comprising at least one hole 22 of a size that the lid 21 can fit through.
